(19) United States
(12) Patent Application Publication
(10) Pub. No.: US 2012/0043434 A1
(43) Pub. Date: Feb. 23, 2012

(54) POWERED GATE POST WITH SLOTS FOR POSITIONAL ADJUSTMENT

(76) Inventor: Edward J. Stull, Oxford, MI (US)

(21) Appl. No.: 13/263,762

(22) PCT Filed: Apr. 9, 2010
(86) PCT No.: PCT/US10/30461

§ 371 Date: Nov. 1, 2011

Related U.S. Application Data
(60) Provisional application No. 61/168,256, filed on Apr. 10, 2009.
(60) Provisional application No. 61/304,845, filed on Feb. 16, 2010.

(51) Int. Cl. F16M 11/04; F16M 11/20

(52) U.S. Cl. 248/125.1; 248/176.1

(57) ABSTRACT

A powered gate assembly includes powered posts that support gates. Each of the powered posts includes a rotating outer housing that includes channels within which are mounted brackets that provide infinite adjustable positions for each of the gates. Each of the gates is attached to the powered posts by adjustable brackets that provide vertical and horizontal adjustment of the gates relative to each other and the outer posts.

### CROSS REFERENCE TO RELATED APPLICATIONS

This application claims priority to U.S. Provisional Application No. 61/168,256 which was filed on Apr. 10, 2009, and U.S. Provisional Application No. 61/304,845 which was filed on Feb. 16, 2010.

### BACKGROUND

This disclosure relates generally to a powered gate post assembly that includes slots that provide for adjustable attachment of a gate, and further adjustment to accommodate many different spacing of gate rails.

Large gates utilized for security and to provide privacy are often opened by way of an actuator. The actuator provides for opening and closing of the gate without having to leave the safety and comfort of a vehicle. A rotating post is typically fabricated with specifically located mounting holes or features. A bracket is then attached to the rotating post at these attachment points. As the holes or other mounting features have a predetermined location, the gate can only me mounted at those predefined positions, or additional holes must be fabricated to accommodate different desired mounting locations.

### SUMMARY

A disclosed powered gate assembly includes powered posts that support gates. Each of the powered posts includes a rotating outer housing that includes channels that provide infinite adjustable positions for brackets supporting each of the gates. The powered post is mounted next to, or can also be mounted to the fixed post. The powered posts rotate to move the gates between open and closed positions. Each of the gates are attached to the powered posts by adjustable brackets. The adjustable brackets provide vertical and horizontal adjustment of the gates relative to each other and the outer posts.

These and other features disclosed herein can be best understood from the following specification and drawings, the following of which is a brief description.

### BRIEF DESCRIPTION OF THE DRAWINGS

FIG. 1 is a schematic view of an example powered gate system.

FIG. 2 is a cross-sectional view of an outer rotating housing.

FIG. 3 is a sectional view of the outer rotating housing and mounting bracket.

FIG. 4 is a perspective view of an example bracket mounted to the outer rotating housing.

FIG. 5 is a perspective view of another adaptor for the mounting bracket.

FIG. 6 is a perspective view of another adaptor for the mounting bracket.

FIG. 7 is a cross-sectional view of another outer rotating tube.

FIG. 8 is a perspective view of another example bracket.

FIG. 9 is a front view of bracket mounted to the outer rotating tube.

FIG. 10 is a cross sectional view of an attachment member for mounting the bracket to the outer rotating tube.

### DETAILED DESCRIPTION

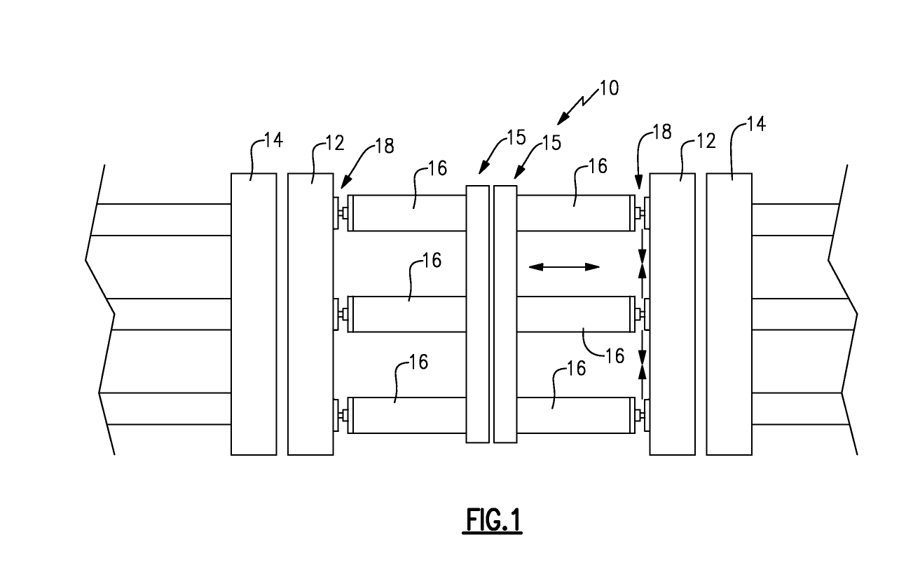

Referring to FIG. 1, a powered gate assembly 10 includes powered posts 12 that support rails 16 of corresponding gates 15. The gates provide an opening through a fence that ends in a fixed post 14. The powered post 12 is mounted next to, or can also be mounted to the fixed post 12. The powered posts 12 rotate to move the gates 15 between open and closed positions. The rails 16 are attached to the powered posts 12 through adjustable mounting brackets 18. The adjustable brackets 18 allow adjustment of the rails 16 vertically in one of an infinite number of positions along the outer post 12. The vertical position of the corresponding gate can be adjusted by sliding along the rotating posts 12. Further, each of the adjustable brackets 18 provide for adjustment horizontally such that the ends of the gates 15 can be aligned and a gap between the gates 15 can be set as desired.

Referring to FIGS. 2-4, the powered post 12 is supported on a fixed support 35 that defines an internal cavity 37. An actuator 27 is disposed within the inner cavity 37 and includes a shaft 29 that extends through slots 39 in the support 25. Cams 31 are supported at the end of the shaft 29 and ride within inner channels 35. The slots 39 twist about the support 25 such that longitudinal motion provided by the actuator 27 is translated into rotational motion of the post 12.

The brackets 18 include a slider 20 that fits within channels 33 formed in the post 12. The slider includes a lip 32 that engages an inner surface of a flange 30 that defines the channels 33. The channels 33 run the entire length of the post 12 and therefore allow an unlimited number of adjustment positions. Moreover, the number of brackets 18 can be adjusted to accommodate any style of gate 15.

A threaded rod 22 is threadingly engaged to the slider 22 and engages the portion 36 of the post 12. The interface 34 between the end of the threaded rod 22 and the post portion 36 secures the bracket 18 in a desired vertical position on the post 12. Flats 24 on the threaded rod 22 provide for the use of a wrench to turn the rod 22 into forced contact at the interface 34. The forced contact between the rod 22 and the portion 36 drives the lips 32 outward against the inner surface of the flanges 30. The flanges 30 and lips 32 are sized to withstand the forces encountered by the interface 34 along with the weight exerted by the gate 15.

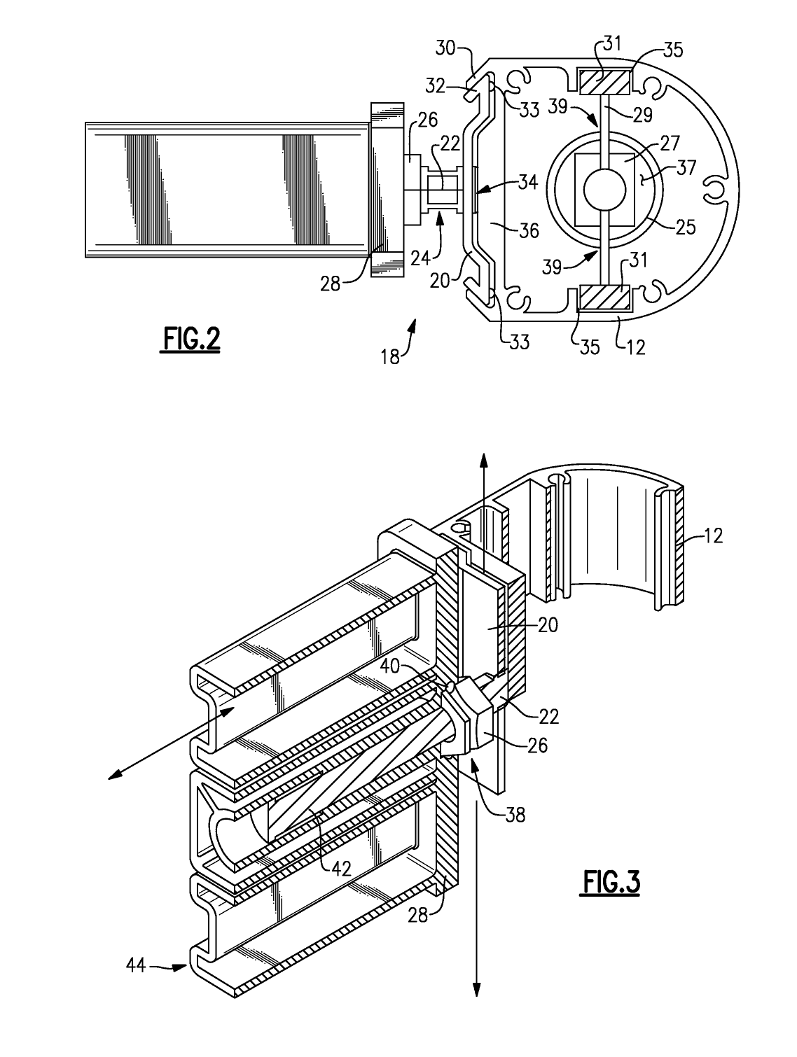

An adjustment nut 26 is threaded movable along the rod 22 and provides for horizontal movement of the adaptor 28. The adaptor 28 fits within a portion of the gate 15. In this example, the adaptor 28 fits within the rails 16. The example rails can be hollow structures constructed of plastic, metal or any other material utilized to construct a gate assembly 18. The nut 26 includes a groove 38 (best shown in FIG. 3) that receives a pin 40 that is mounted within the adaptor 28. The pin 40 and groove 38 interface maintains the nut 26 in position with the adaptor 28 such that rotation of the nut 26 along the rod 22 causes movement of the adaptor 28. The adaptor 28 can therefore be moved horizontally to provide further adjustment and alignment of the gates 15.

The example adaptor 28 is fabricated from a plastic material and includes a shape and configuration that mates within the rails 16. The example configuration includes three separate closed shapes that interface with features of the rails 16. As appreciated, the specific configuration of each shape can be altered to accommodate application specific parameters.

Referring to FIG. 5, another adaptor 46 includes a flange 48 with openings 50 for receiving fasteners to secure another gate configuration. In this example, the adaptor 46 can be mounted to support a gate on a face, such as for a wooden privacy fence of for simply securing a wood fence rail. Moreover, the adaptor 46 could be utilized to secure gates fabricated from any material where a face mounted bracket is needed and/or desired.

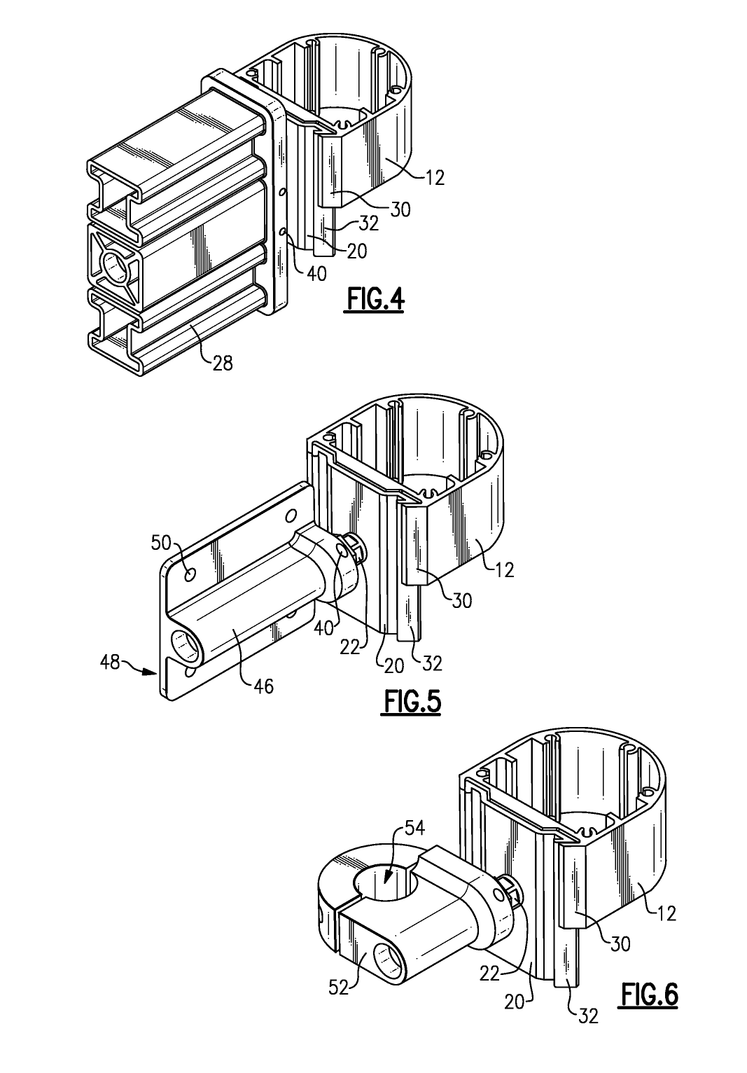

Referring to FIG. 6, another adaptor 52 includes an opening 54 for receiving a tubular member such is commonly utilized for a tubular farm style gate. The adaptor 52 is split into two parts to receive a tubular portion of a gate. The adaptor 52 can then be secured together with the provided threaded fasteners. The adaptor 52 maintains the adjustability described with the previous adaptors. The slider 20 can be moved vertically within the channels 33 and then secured in a desired position the nut 26 is provided and is threadingly movable to move the adaptor 52, and thereby the mounted gate, horizontally. Accordingly, several example adaptors have been disclosed and it should be appreciated that additionally adaptors could be utilized and created to fulfill application specific needs.

Referring to FIG. 7 is a cross-section of another outer rotating tube 72. The outer rotating tube 72 has a D-shaped cross-sectional configuration to provide a constant distance during rotation of the outer rotating tube 72 between the fixed post 14 and the rotating outer rotating tube 72. The outer rotating tube 72 includes a curved surface 74 and a flat side 76. The curved surface 74 is positioned adjacent the fixed post 14 and provides the desired constant spacing during rotation of the gate assembly 10.

The outer rotating tube 72 includes a guide channels 78 disposed on an internal surface 80. The guide channels 78 receive cams 31 that are attached to a drive shaft 29 of an actuator 27 (shown in FIG. 2). The outer rotating tube 72 includes two channels 82 located on the flat side 76 that extend along the length of the outer rotating tube 72. That is, the channels 82 extend longitudinally along the entire length of the tube 72.

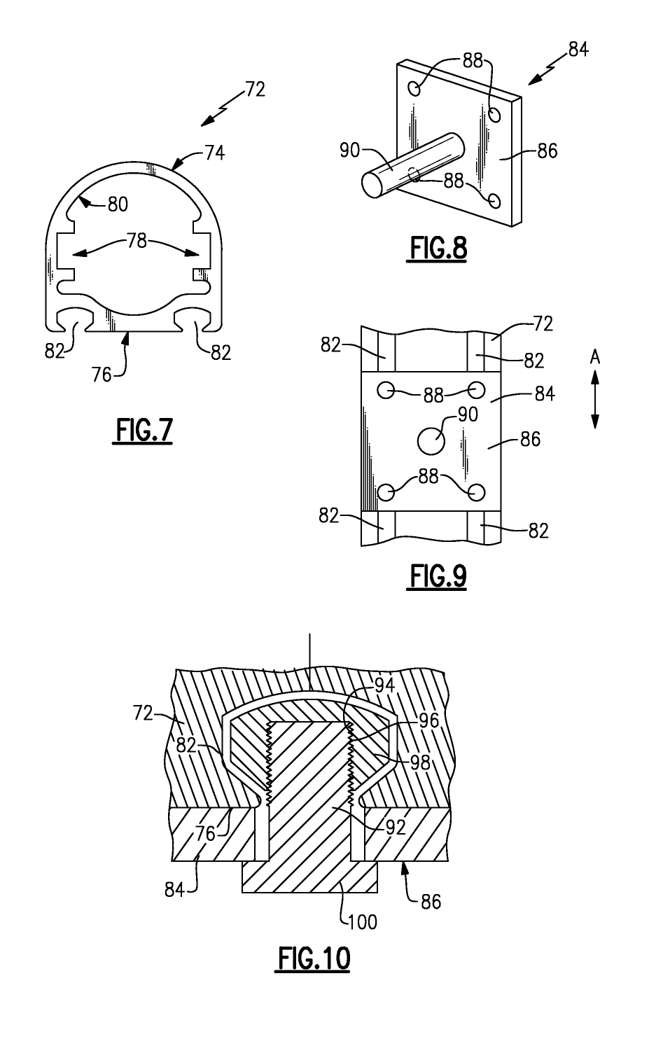

FIG. 8 is a perspective view of a bracket 84. The bracket 84 includes a planar portion 86 including holes 88. In one example, the bracket 84 is substantially square and includes one hole 88 near each corner. The bracket 84 includes an attachment feature 90 that attaches to one of the gates 15. The attachment feature 90 can be a rod (as shown), a ring, or a planar piece substantially parallel to the planar portion 86.

FIGS. 9 and 10 shows the bracket 84 and the outer rotating tube 72. The planar portion 86 of the bracket 84 is positioned against the flat surface 76 of the outer rotating tube 72. Two holes 88 of the bracket 84 are aligned with one of the channels 82.

The position of the bracket 84 (which is attached to the gate 12) is adjustable along the length of the rotating tube 72.

Referring to FIG. 10, an attachment system secures the bracket 84 to the outer rotating tube 72 in the desired position. The attachment system includes a screw 92 including an external thread 94 that is received in each of the holes 88 of the bracket 84. A corresponding dog 98 (or nut) including an internal thread 96 is received in the channel 82. In one example, the dog 98 is stainless steel. There is one dog 98 for each screw 92. Each bracket 84 is secured to the outer rotating tube 726 with four dogs 98 and four screws 92. The external threads 94 of each screw 92 engage with the internal thread 96 of each dog 98 to secure the bracket 84 to the outer rotating tube 72. The screw 92 is turned until a head 100 of the screw 92 engages and applies pressure to an outer surface of the planar portion 86 and the flat surface 76. Once all the screws 92 are tightened, the bracket 84 is retained in a desired longitudinal position relative to the outer rotating tube 72.

The screws 92 can be loosened to allow the bracket 84 to slide relative to the outer rotating tube 72 along the axis A. The associated dogs 98 slide within the channels 82 to provide vertical movement of the bracket 84 along the outer rotating tube 72. Accordingly, the gate 15 attached to the bracket 84 can be positioned along the axis A such that the height and vertical position of the gate 15 can be adjusted relative to the fixed structure 22. Moreover, the relative position of the gates 15 can be set relative to each other and at a desired vertical position.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A powered post assembly for supporting a gate comprising:
an outer housing rotatably supported on the support, the outer housing including at least one channel for receiving a slider that is fixable within the channel in an infinite number of positions along the outer housing.

2. The powered post assembly as recited in claim 1, including a bracket attachable to the slider for attaching the gate to the outer housing.

3. The powered post assembly as recited in claim 1, wherein the slider includes a bracket for supporting a portion of the gate and a threaded member that extends through the slider to engage the housing and fix a position of the slider on the outer housing.

4. The powered post assembly as recited in claim 1, wherein the at least one channel comprises first and second channels disposed on opposite edges of a common side of the outer housing.

5. The powered post assembly as recited in claim 4, wherein the slider comprises first and second ends that are disposed in corresponding first and second channels.

6. The powered post assembly as recited in claim 5, wherein each of the first and second channels include an inner wall and the first and second ends of the slider include an outer wall that engages the inner wall of the outer housing for fixing the slider in a desired position.

7. The powered post assembly as recited in claim 6, including a threaded member extending through the slider to engage a surface of the outer housing thereby forcing the outer wall of the slider into contact with the inner wall of each of the first and second channels to secure the slider in the desired position.

8. The powered post assembly as recited in claim 7, wherein a bracket is attached to the slider and is movable horizontally relative to the slider to adjust a horizontal position of the gate.

9. The powered post assembly as recited in claim 8, including a threaded rod extending from the slider to which the bracket is secured, the bracket movable along the threaded rod for adjusting a horizontal position of the bracket relative to the slider.

10. The powered post assembly as recited in claim 1, wherein the outer housing includes a first side including the at least one channel, a second side opposite the first side and third and forth sides disposed between the first and second sides.

11. The powered post assembly as recited in claim 10, wherein the second side comprises a curved surface and the third and forth sides comprise flat surface parallel to each other.

12. The powered post assembly as recited in claim 1, including an inner surface of the outer housing, the inner surface including guide slots for engaging a driving cam of an actuator for driving rotation of the outer housing relative to a fixed support.

13. A powered post assembly comprising:
a support defining an inner cavity;
an actuator supported within the inner cavity;
an outer housing rotatably supported on the support, the outer housing including at least one channel; and
a slider that is fixable within the at least one channel in an infinite number of positions along the outer housing.

14. The powered post assembly as recited in claim 13, wherein the outer housing includes inner guide channels that receive cams driven by the actuator.

15. The powered post assembly as recited in claim 13, wherein the at least one channel comprises first and second channels at opposite edges of a first side of the outer housing.

16. The powered post assembly as recited in claim 15, wherein the slider includes first and second end portions received within a corresponding one of the first and second channels.

17. The powered post assembly as recited in claim 16, including a threaded member that extends through the slider and engages the outer housing for securing the slider at a desired location on the outer housing.

18. The powered post assembly as recited in claim 13, including a bracket secured to the slider for supporting a rail member of a gate.

19. The powered post assembly as recited in claim 18, including a threaded member disposed between the slider and the bracket for adjusting a distance between the slider and the bracket.
